(19) United States
(12) Patent Application Publication
(10) Pub. No.: US 2023/0414005 A1
(43) Pub. Date: Dec. 28, 2023

(54) BODY SUPPORT ARTICLES CO-PACKAGED WITH COMPOSITIONS COMPRISING ANTIMICROBIAL AND/OR ANTIVIRAL COMPOUND(S) AND SCENTING AGENTS; METHODS AND SYSTEMS FOR CO-PACKAGING SAME

(71) Applicant: SINOMAX USA INC., Houston, TX (US)

(72) Inventor: John Beliveau, Morrisville, NC (US)

(73) Assignee: SINOMAX USA INC., Houston, TX (US)

(21) Appl. No.: 17/848,279

(22) Filed: Jun. 23, 2022

Related U.S. Application Data
(63) Continuation of application No. 17/848,109, filed on Jun. 23, 2022.

(51) Int. Cl. A47C 27/05; A01N 43/76; A01N 33/12; A01N 59/20; A01N 31/08

(52) U.S. Cl. CPC A47C 27/05; A01N 43/76; A01N 33/12; A01N 59/20; A01N 31/08; A47G 2009/1018

(57) ABSTRACT

A packaged body support article, comprising a compressed and rolled body support article predominantly comprising one or more foams; a sealed, airtight material maintaining the body support article in the rolled state; and a container comprising a dispensing port and housing the composition. Methods and systems for forming the packaged body support article.

### BACKGROUND OF THE INVENTION

### Field of the Invention

Generally, the present disclosure relates to compositions comprising antimicrobial and/or antiviral compound(s), and, more specifically, to application of such compound(s) on surfaces, such as body support articles co-packaged with such compositions.

### Description of the Related Art

Biohazards, such as bacteria, virus, etc., attaching themselves on materials are of concern. The coronavirus pandemic of 2019-2021 emphasizes the need for people to avoid infectious agents in their environment. This is of especial interest with regards to body support articles, such as mattresses, mattress toppers, pillows, cushions, and the like. People typically spend 6-8 hours per night in bed, and much additional time seated on cushions or pillows. The long durations of exposure of people to surfaces that may receive bodily fluids and secretions, along with the desire for safety in one's bed and furniture for seating, call for improvements in rendering body support articles less contaminated with infectious agents.

Accordingly, it would be desirable to reduce the survivability of infectious agents on body support articles, both at the time of purchase and subsequent thereto.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a packaged body support article, comprising: a body support article predominantly comprising one or more foams, wherein the body support article is compressed and rolled; a sealed, airtight material maintaining the body support article in the rolled state; and a container comprising a dispensing port and housing the composition referred to above.

In one embodiment, the present disclosure is directed to a method, comprising forming a body support article predominantly comprising one or more foams; compressing the body support article; rolling the body support article; sealing the compressed and rolled body support article in an airtight material; positioning the sealed body support article in a packaging article; and including in the packaging article a container comprising a dispensing port and housing the composition referred to above.

In one embodiment, the present disclosure is directed to a system, comprising a processing controller configured to control a body support article packaging system; and the body support article packaging system, wherein the body support article packaging system is configured to: form a body support article predominantly comprising one or more foams; compress the body support article; roll the body support article; seal the compressed and rolled body support article in an airtight material; position the sealed body support article in a packaging article; and include in the packaging article a container comprising a dispensing port and housing the composition referred to above.

The present disclosure may provide for convenient treatment of body support articles with antimicrobial and/or antiviral compounds.

### BRIEF DESCRIPTION OF THE DRAWINGS

The disclosure may be understood by reference to the following description taken in conjunction with the accompanying drawings, in which like reference numerals identify like elements, and in which:

FIG. 1A conceptually depicts a packaged body support article, in accordance with embodiments herein.

FIG. 1B conceptually depicts a packaged body support article, in accordance with embodiments herein.

FIG. 1C conceptually depicts a body support article, in accordance with embodiments herein.

FIG. 1D conceptually depicts a body support article, in accordance with alternative embodiments herein.

FIG. 2A is a flowchart of a method, in accordance with embodiments herein.

FIG. 2B is a flowchart of a method, in accordance with alternative embodiments herein.

FIG. 3A is a schematic representation of a system, in accordance with embodiments herein.

FIG. 3B is a schematic representation of a system, in accordance with alternative embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In one embodiment, the present disclosure relates to a composition or solution, comprising a solvent; a compound selected from antimicrobial compounds or antiviral compounds; and a scenting agent; wherein the compound and the scenting agent are soluble in the solvent and/or emulsifiable in the solvent; the solvent, the compound, and the scenting agent are present in the composition at concentrations such that the amount of each in 0.5 liters of the composition are non-toxic to humans, dogs, and cats; the solvent readily evaporates at room temperature and 100% relative humidity; and the composition is capable of application as a spray or an aerosol to a surface.

The solvent may be any substance in which the compound selected from antimicrobial compounds or antiviral compounds may be dissolved or aerosolized, optionally with the help of an emulsifier; is non-toxic; readily evaporates at room temperature and 100% relative humidity; and which allows application of the composition as a spray or an aerosol.

In one embodiment, the solvent may be water, alcohol, or a combination thereof. In another embodiment, the solvent may be a hydrophobic compound. This latter embodiment of the solvent may be useful when the compound is hydrophobic, i.e., generally insoluble in water. A particular solvent may be selected as a routine matter by the person of ordinary skill in the art having the benefit of the present disclosure.

The composition or solution of this embodiment additionally comprises a compound selected from antimicrobial compounds or antiviral compounds. “Antimicrobial compound,” as the phrase is used herein, generally means that the compound is fatal to and/or inhibits the growth and/or reproduction of at least one bacterium, mold, and/or mildew. “Antiviral compound,” as the phrase is used herein, generally means that the compound destroys at least one virus or inhibits the infectiveness thereof. The person of ordinary skill in the art will understand that a compound selected from antimicrobial compounds or antiviral compounds performs the relevant function by having structural features that are harmful or fatal to one or more microorganisms or destroy or inhibit one or more viruses.

The composition or solution of embodiments herein may be applied to various types of surfaces, including but not limited to, body support articles, packaging of body support articles, cushions, clothing, draperies, carpets, rugs, furniture upholstery, furniture, countertops, packages, shipping packages, and/or the like.

Exemplary antimicrobial and/or antiviral compounds include, but are not limited to, silver ion compounds; zinc compounds; copper compounds; quaternary ammonium compounds (“quats”), for example, N-alkyl dimethyl benzyl ammonium chloride, N-octyl decyl dimethyl ammonium chloride, di-n-decyl dimethyl ammonium chloride, and di-n-octyl dimethyl ammonium chloride; oxazoline homopolymers, e.g., poly(2-ethyl-2-oxazoline); oxazoline copolymers, such as with a heterocyclic comonomer; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles, e.g. propiconazole; polyhexamethylene biguanide hydrochloride; 3,4,4′-trichlorocarbanilide; isothiazolone-based compounds, such as 1,2-benzisothiazolin-3-one, N-butyl-1,2-benzisothiazolin-3-one, 2-octyl-isothiazolone, 4,5-dichloro-2-N-octyl-3(2H)-isothiazolone, methyl-3(2H)-isothiazolone, or chloro-2-methyl-3(2H)-isothiazolone; alkyl dimethyl ammonium saccharinate; benzalkonium chlorides; oxathiazines; or chlorothalonil. Numerous antimicrobial and/or antiviral technologies are commercially available from Microban International, Ltd., Huntersville, NC.

The composition of this embodiment may comprise two or more antimicrobial compounds, two or more antiviral compounds, and/or one or more antimicrobial compounds and one or more antiviral compounds. In one embodiment, the composition may comprise from 0.2 to 3 parts by weight of an oxazoline homopolymer and from 0.05 to 20 parts by weight of a quat.

The composition may further comprise a scenting agent. “Scenting agent,” as the phrase is used herein, generally means” a compound having a structure that binds to olfactory receptors in the human nose such that the typical consumer perceives the compound as having a pleasant aroma. Scenting agents are well-known in the art, and include natural and man-made compounds imparting aromas perceived as being one or more of floral, citrusy, fruity, herbal, spicy, clean, rainy, fresh, etc.

In one embodiment, the scenting agent imparts a lavender scent.

In one embodiment, the composition may further comprise an emulsifier. “Emulsifier,” as the term is used herein, generally means a compound that has structural features that enable it to associate through non-covalent interactions with the solvent and with one or more of the compound, the scenting agent, or both. By doing so, the solubility of the compound, the scenting agent, or both in the solvent may be enhanced.

In other embodiments, the composition may further comprise one or more other materials.

In one embodiment, the composition may further comprise an essential oil. In a particular embodiment, the essential oil is selected from the group consisting of green tea oil, sweet orange oil, menthol oil, peppermint oil, cedarwood oil, lemon oil, eucalyptus oil, aromatic litsea/mountain pepper oil, clove oil, spearmint oil, rose oil, lemongrass oil, lavender oil, thyme oil, alfalfa oil, allspice oil, ambrette (seed) oil, angelica root oil, angelica seed oil, angelica stem oil, angostura (cusparia bark) oil, anise oil, asafetida-foetida oil, balm (lemon balm) oil, balsam of peru oil, basil oil, bay leaves oil, bay (myrcia oil) oil, bergamot (bergamot orange) oil, bitter almond oil, bois de rose oil, cacao oil, camomile (chamomile) flowers oil, cananga oil, capsicum oil, caraway oil, cardamom seed (cardamon) oil, carob bean oil, carrot oil, cascarilla bark oil, cassia bark oil, chinese oil, cassia bark oil, padang or batavia oil, cassia bark oil, saigon oil, celery seed oil, cherry oil, wild oil, bark oil, chervil oil, chicory oil, cinnamon bark oil, ceylon oil, cinnamon bark oil, chinese oil, cinnamon bark oil, saigon oil, cinnamon leaf oil, ceylon oil, cinnamon leaf oil, chinese oil, cinnamon leaf oil, saigon oil, citronella oil, citrus peels oil, clary (clary sage) oil, clover oil, coca (decocainized) oil, coffee oil, cola nut oil, coriander oil, cumin (cummin) oil, curacao orange peel (orange oil, bit oil, cusparia bark oil, dandelion oil, dandelion root oil, dog grass (quackgrass oil, triticum) oil, elder flowers oil, estragole (esdragol oil, esdragon oil, t oil, estragon (tarragon) oil, fennel oil, sweet oil, fenugreek-gr oil, galanga (galangal) oil, geranium oil, east indian oil, rose oil, ginger oil, grapefruit oil, guava oil, hickory bark oil, horehound (hoarhound) oil, hops oil, horsemint oil, hyssop oil, immortelle oil, jasmine oil, juniper (berries) oil, kola nut oil, laurel berries oil, laurel leaves oil, lavender oil, lavender oil, spike oil, lavandin oil, lemon(l.) burm. oil, lemon balm oil, lemongrass oil, lemon peel(l.) oil, lime oil, linden flowers oil, locust bean oil, oil, lupulin oil, mace oil, mandarin oil, marjoram oil, sweet oil, yerba mate oil, melissa (see balm) oil, menthol oil, menthyl acetate oil, molasses (extract) oil, mustard oil, naringin oil, neroli oil, bigarade oil, nutmeg oil, onion oil, orange oil, bitter oil, flowers oil, orange oil, bitter oil, peel oil, orange leaf(l.) oil, orange oil, sweet oil, orange oil, sweet oil, flowers oil, orange oil, sweet oil, peel oil, origanum oil, palmarosa oil, paprika oil, parsley(mi oil, pepper oil, black oil, pepper oil, white oil, peppermint oil, peruvian balsam oil, petitgrain oil, petitgrain lemon oil, petitgrain mandarin or tangerine oil, pimenta oil, pimenta leaf oil, pipsissewa leaves oil, pomegranate oil, prickly ash bark oil, rose absolute oil, rose (otto of roses oil, attar of roses) oil, rose buds oil, rose flowers oil, rose fruit (hips) oil, rose geranium oil, rose leaves oil, rosemary oil, saffron oil, sage oil, sage oil, greek oil, sage oil, spanish oil, st. john's bread oil, savory oil, summer oil, savory oil, winter oil, schinus molle oil, sloe berries (blackthorn berries) oil, spearmint oil, spike lavender oil, tamarind oil, tangerine oil, tarragon oil, tea oil, thyme oil, thyme oil, white oil, thyme oil, wild or creeping oil, tuberose oil, turmeric oil, vanilla oil, violet flowers oil, violet leaves oil, violet leaves absolute oil, wild cherry bark oil, ylang-ylang oil, and zedoary bark oil.

The solvent, the compound selected from antimicrobial compounds or antiviral compounds, the scenting agent, and any other materials may be present in any desired proportions that will be found as a routine matter by the person of ordinary skill in the art having the benefit of the present disclosure.

The composition may be deployed in any container suitable for spray or aerosol application to a surface. In one embodiment, the composition is deployed in a spray bottle for application. In one embodiment, the composition is deployed in an aerosol can for application. Spray bottles and aerosol cans are known technologies in which the composition can be deployed as a routine matter by the person of ordinary skill in the art having the benefit of the present disclosure.

However, the composition is applied to a surface, the solvent's ready evaporability at room temperature and 100% relative humidity will generally lead to the solvent quickly evaporating from the surface, leaving the antimicrobial and/or antiviral compound and the scenting agent on the surface. As a result, application of the composition may lead to a pleasantly-scented surface with antimicrobial and/or antiviral properties.

In another embodiment, the present disclosure relates to a packaged body support article, comprising: a body support article predominantly comprising one or more foams, wherein the body support article is compressed and rolled; a sealed, airtight material maintaining the body support article in the rolled state; and a container comprising a dispensing port and housing a composition, wherein the composition comprises: a solvent; a compound selected from antimicrobial compounds and/or antiviral compounds; and a scenting agent; wherein the compound and the scenting agent are soluble in the solvent and/or emulsifiable in the solvent. The solvent, the compound, and the scenting agent are present in the composition at concentrations such that the amount of each in 0.5 liters of the composition are non-toxic to humans, dogs, and cats; the solvent readily evaporates at room temperature and 100% relative humidity; and the composition is capable of application as a spray or an aerosol to a surface.

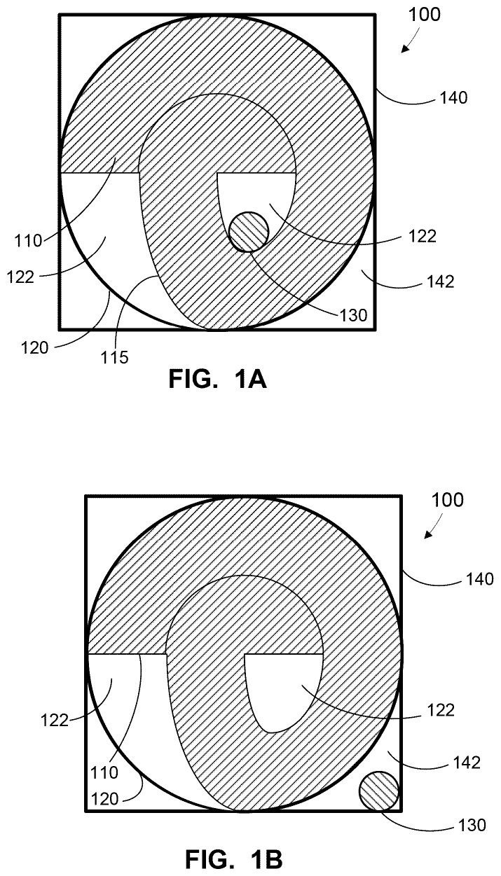

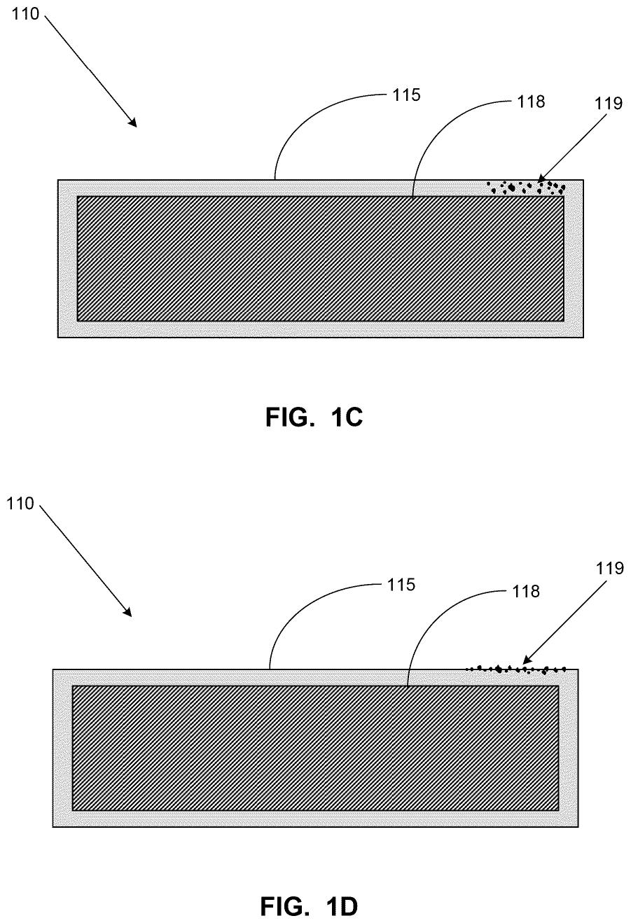

FIG. 1A and FIG. 1B present schematic views of exemplary packaged body support articles 100. In both FIG. 1A and FIG. 1B, a body support article 110 is shown in a rolled state. In embodiments, the body support article 110 may be a mattress, a mattress topper, a pillow, a cushion, or the like. The body support article 110 predominantly comprises one or more foams, such as viscoelastic foam or non-viscoelastic foam. “Predominantly comprises,” as the phrase is used herein, generally means that the foam(s) make up more than 50 weight percent (wt %) of the body support article 110, such as more than 60 wt %, more than 70 wt %, more than 80 wt %, more than 90 wt %, more than 95 wt %, or more than 99 wt %.

The body support article 110 includes a cover layer 115, which encapsulates one or more components of the body support article 110. For example, one or more foam layers, support members, etc., may be encapsulated by the cover layer 115. The composition described herein may be placed upon the surface of the body support article 110.

Particular body support articles 110 may be chosen as a routine matter by the person of ordinary skill in the art having the benefit of the present disclosure. For example, the body support articles 110 may be a mattress, a pillow, a mattress cover, a cushion, and/or the like.

The compressing and rolling of foam mattresses, pillows, etc. is known in the art.

Typically, a foam object is compressed and held in a compressed state by an inner airtight material (not shown), rolled into a spiral-like shape as shown for body support article 110 in FIG. 1A and FIG. 1B, and sealed by an outer airtight material 120 that maintains the body support article 110 in the rolled shape. Typical airtight materials include plastics. Techniques for compressing, rolling, and sealing body support articles 110 in airtight materials 120 are known in the art and need not be described further.

The process of sealing the rolled body support article 110 within the airtight material 120 typically yields one or more voids 122, the size of which has been exaggerated in FIG. 1A and FIG. 1B for readability. In the embodiment shown in FIG. 1A, a container 130 of the composition may be included in a void 122 inside the airtight material 120.

The composition in the container 130 is as described above. The container 130 may be a spray bottle or an aerosol can.

The packaged body support article 100 may further comprise a packaging article 140 configured to confine the container 130 and the body support article 110 maintained in the compressed and rolled state by the sealed, airtight material 120.

In one embodiment, the packaging article 140 may comprise cardboard, paper, paperboard, metal, viscoelastic foam, flexible plastic, rigid plastic, or two or more thereof. Alternatively, or in addition, the interior of the packaging article 140 may comprise one or more spacer or packer elements, such as foamed styrene, rigid cardboard, or the like (not shown).

In the embodiment shown in FIG. 1B, the container 130 is confined inside the packaging article 140 and outside the sealed, airtight material 120. The container 130 may be loose inside the packaging article 140 or may be secured, by plastic ties, twine, cord, recesses formed of the same material as the packaging article 140, spacer or packer elements, etc.

In another embodiment, not shown, the body support article 110 may comprise one or more pockets or recesses. The pocket(s) or recess(es) may be sized and shaped such that at least one of them may receive and hold the container 130. This may allow the consumer to readily access the container 130 when he or she wishes to apply the composition to one or more surfaces of the body support article 110. The container 130 may be included with the packaged body support article 100 inside the pocket/recess of the body support article 110 but need not be.

The packaged body support article 100 provides an advantage in that a container of the composition comprising an antimicrobial and/or antiviral compound and a scenting agent is provided to the end user at the time of unpacking the body support article 110 and readying it for first use. Instructions packed in the packaged body support article 100 may instruct the user to apply the composition in the container 130 to surfaces of the body support article 110 while the body support article 110 decompresses or subsequently thereto. Also, the container 130 may house more of the composition than is needed for an initial application, thereby allowing convenient reapplication of the composition when its antimicrobial and/or antiviral properties or its scenting activity may become attenuated. Doing so reduces the consumer's need to remember to separately buy or maintain on hand an antimicrobial and/or antiviral agent at the time of unpacking. The container 130 may be manufactured to be cobranded with the packaged body support article 100, thereby creating an association between the body support article 110 and the composition which would allow the sale of the container 130 separately, possibly at a price premium relative to generic antimicrobial and/or antiviral agents.

Turning now simultaneously to FIGS. 1C and 1D, stylized diagrams of a body support article of various embodiments herein, is illustrated. The body support article 110 may comprise a plurality of inner layers 118. The inner layer 118 depicted in FIG. 1C may be representative of a plurality of layers, e.g., foam layers, support member layers, etc.

The inner layers 118 may be encapsulated by a cover layer 115. The cover layer 115 may be comprised of one or more materials, such as cloth material, foam material, etc. In some embodiments, the composition comprising an antimicrobial compound and/or an antiviral compounds, as well as a scented agent, as described herein, may be infused into the cover layer 115. At least a portion of the composition may be infused into the cover layer 115 to form an infused composition 119 as stylized in FIG. 1C. FIG. 1C shows the infused composition 119 only in a portion of the cover layer 115 for ease of illustration; however, those skilled in the art having benefit of the present disclosure would appreciate that the infused composition 119 may be applied to a broader area of the inner layer 115. In one embodiment, the infused composition 119 may be uniformly distributed on the top portion of the body support article 110.

In another embodiment, the infused composition 119 may be distributed also to other portions of the cover layer 115, such as the side portions of the body support article 110 and/or on the bottom portion of the body support article 110. In some embodiments, the application of the infused composition 119 may be performed by using the infused composition 119 in the form of an aerosol or as a spray to apply to on the cover layer 115.

In alternative embodiments, the composition comprises an antimicrobial compound and/or an antiviral compound, as well as a scented agent, as described herein, may be placed on the surface of the cover layer 115 to form a surface composition 121, as exemplified in FIG. 1D. FIG. 1D shows the surface composition 121 only with respect to a portion of the cover layer 115 for ease of illustration; however, those skilled in the art having benefit of the present disclosure would appreciate that the surface composition 121 may be applied to a broader area of the cover layer 115.

In one embodiment, the surface composition 121 may be more uniformly distributed on the top portion of the body support article 110. In another embodiment, the surface composition 121 may be distributed also to other portions of the cover layer 115, such as the side portions of the body support article 110 and/or on the bottom portion. The application of the surface composition 121 may be performed by using the surface composition 121 in the form of an aerosol or as a spray to apply to on the cover layer 115. The body support article 110 may be packaged as shown in FIG. 1A and accompanying descriptions herein.

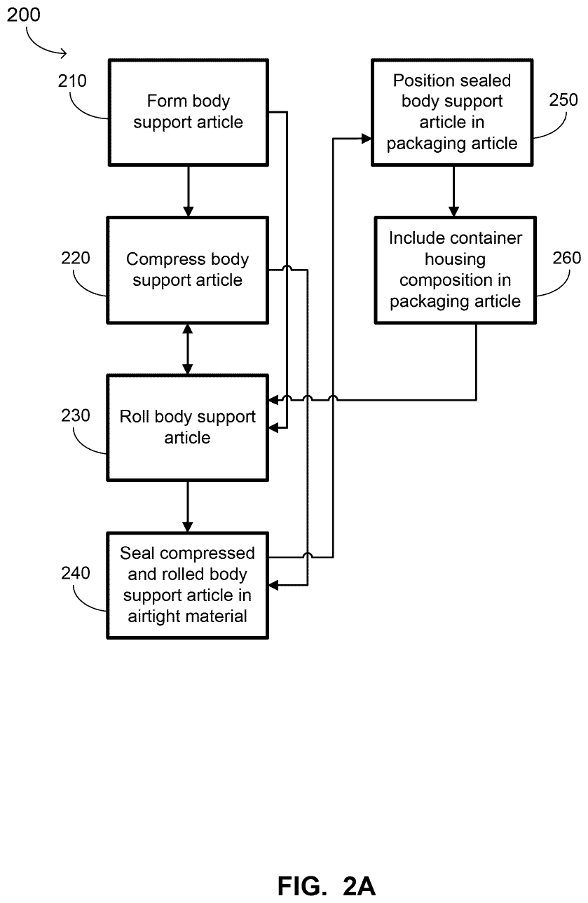

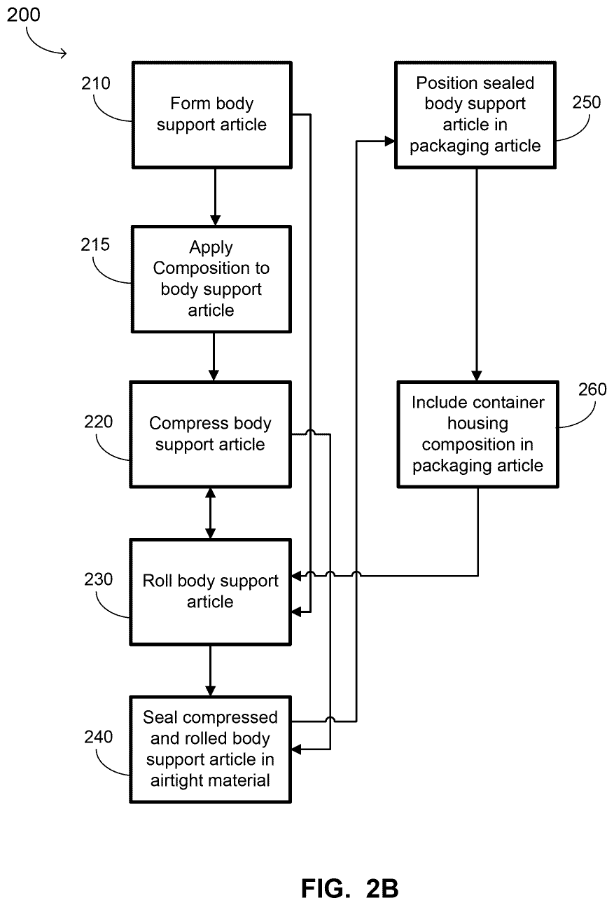

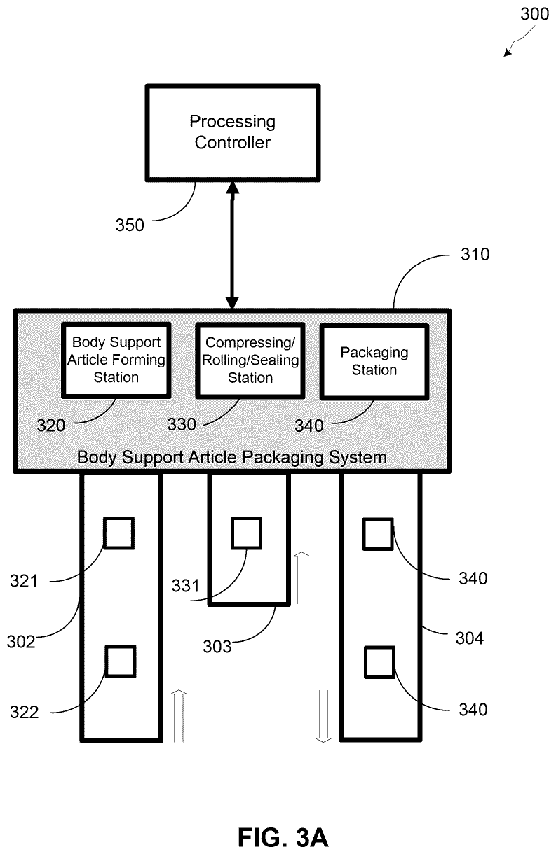

FIG. 2A is a flowchart of a method 200, in accordance with embodiments herein. FIG. 2B is a flowchart of a method 200, in accordance with alternative embodiments herein. Referring simultaneously to FIGS. 2A and 2B, the method 200 comprises forming (at 210) a body support article predominantly comprising one or more foams. The body support article may be as described above. Techniques for forming body support articles predominantly comprising one or more foams are known to the person of ordinary skill in the art having the benefit of the present disclosure and need not be described in detail. In some embodiments, as exemplified in FIG. 2B, the composition described herein may be applied to the body support article (at 215, FIG. 2B). In this manner, upon packaging the body support article, the article may already be treated with the composition, thereby providing a possible increase in anti-bacterial and/or anti-viral protection.

The example illustrated in FIG. 2A may not include step 215.

The method 200 also comprises compressing (at 220) the body support article. Techniques for compressing body support articles are well known and implementation thereof will be routine for the person of ordinary skill in the art having the benefit of the present disclosure.

The method 200 also comprises rolling (at 230) the body support article. Rolling the body support article will be a routine matter for the person of ordinary skill in the art having the benefit of the present disclosure.

Although the order of reference numerals of compressing (at 220) and rolling (at 230) may suggest that compressing is performed before rolling, the order of these actions may be varied, or these actions may be performed simultaneously.

Regardless of the order of compressing (at 220) and rolling (at 230), the method 200 comprises sealing (at 240) the compressed and rolled body support article in an airtight material. Techniques for doing so will be apparent to the person of ordinary skill in the art having the benefit of the present disclosure. The airtight material may maintain the body support article in the rolled state for subsequent actions of the method.

The method 200 also comprises positioning (at 250) the sealed body support article in a packaging article. The packaging article may be as described above. Positioning (at 250) will be a routine matter for the person of ordinary skill in the art, bearing in mind that the airtight material should be handled such that its airtight seal of the rolled body support article is maintained.

The method 200 also comprises including (at 260) in the packaging article a container comprising a dispensing port and housing a composition, wherein the composition comprises a solvent; a compound selected from antimicrobial compounds or antiviral compounds; and a scenting agent; wherein the compound and the scenting agent are soluble in the solvent and/or emulsifiable in the solvent; the solvent, the compound, and the scenting agent are present in the composition at concentrations such that the amount of each in 0.5 liters of the composition are non-toxic to humans, dogs, and cats; the solvent readily evaporates at room temperature and 100% relative humidity; and the composition is capable of application as a spray or an aerosol to a surface.

Generally, the composition and the container may be as described above.

Including (at 260) may be performed after the sealed body support article is positioned (at 250) in the packaging article, or it may be performed before or simultaneously with the rolling (at 230), to include the container inside the sealed airtight material with the rolled body support article.

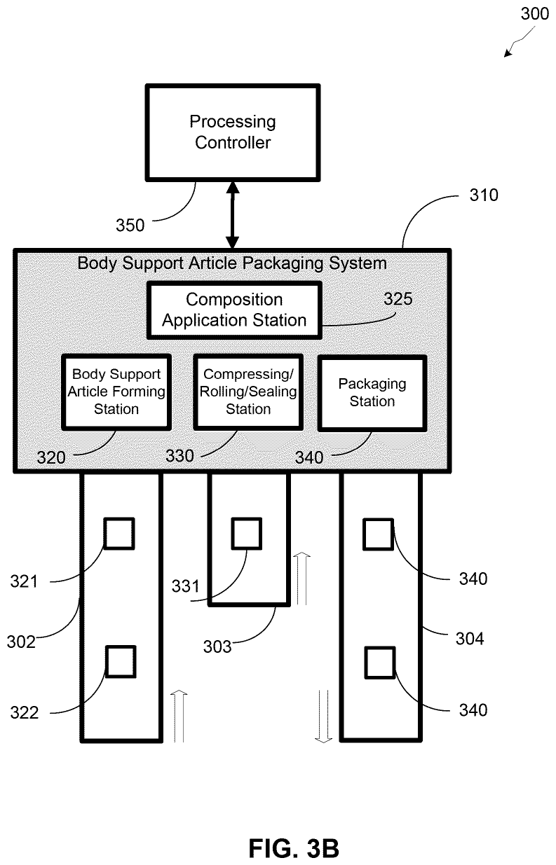

Turning now to FIG. 3A, a stylized depiction of a system 300 for packaging a body support article and a container comprising a composition containing an antimicrobial and/or antiviral compound and a scenting agent, in accordance with embodiments herein, is illustrated. FIG. 3B illustrates a stylized depiction of a system 300 for packaging a body support article and a container comprising a composition containing an antimicrobial and/or antiviral compound and a scenting agent, in accordance with alternative embodiments herein. Referring simultaneously to FIGS. 3A and 3B, a system 300 may comprise a body support article packaging system 310. The body support article packaging system 310 may comprise various processing stations, such as a body support article forming station 320, a compressing/rolling/sealing station 330, a packaging station 340, etc. Data may be gathered from any of the foregoing stations or any other component of the body support article packaging system 310 and may be used to modify one or more process parameters used by the various stations or any other component for performing process steps.

The system 300 may also comprise a processing controller 350. One or more of the processing steps performed by the body support article packaging system 310 may be controlled by the processing controller 350. The processing controller 350 may be a workstation computer, a desktop computer, a laptop computer, a tablet computer, or any other type of computing device comprising one or more software products that are capable of controlling processes, receiving process feedback, receiving test results data, performing learning cycle adjustments, performing process adjustments, etc.

In the particular embodiment depicted schematically in FIG. 3A, the body support article packaging system 310 may receive one or more polyols 321 and one or more isocyanates 322, such as liquids or in solutions via a first piping/pumping system 302 or comparable apparatus. The received polyol(s) 321 and isocyanate(s) 322 may be processed, including by forming of the polyol(s) 321 by the isocyanate(s) 322, at body support article forming station 320, to yield a body support article, as described above. The body support article forming station 320 may comprise any appropriate apparatus known to the person of ordinary skill in the art.

In the system illustrated in FIG. 3B, the body support article packaging system 310 may comprise a composition application station 325. The composition application station 325 is capable of applying the composition to the body support article being processed by the body support article packaging system 310. In some embodiments, the composition application station 325 may apply the composition in one or more application process, such as spraying the composition, wiping the composition, misting the composition, etc. onto the one or more surfaces of the body support article being processed by the body support article packaging system 310. In some embodiments, the composition may be applied in the fashion described in FIGS. 1C and/or 1D, and accompanying description herein.

The body support article packaging system 310 may act upon the body support article at compressing/rolling/sealing station 330 to yield a rolled body support article maintained in the rolled state by an airtight material. The airtight material 331 may be provided by appropriate intake apparatus 303. The compressing/rolling/sealing station 330 may comprise any appropriate apparatus known to the person of ordinary skill in the art.

The body support article packaging system 310 may position, at a packaging station 340, the rolled body support article, to yield a packaged body support article. In embodiments, the packaging station 340 may also include a container comprising the composition described herein in the packaged body support article. In other embodiments, not shown, the container may be co-rolled with the body support article by compressing/rolling/sealing station 330. Apparatus configured to perform these actions will be known to the person of ordinary skill in the art having the benefit of the present disclosure and need not be described in detail.

The packaged body support article may be delivered by the packaging station 340 of the body support article packaging system 310, such as by conveyor belt 304, or comparable conveyance apparatus, to subsequent processing steps, including, but not necessarily limited to, entering the packaged good into commerce. Such subsequent steps will be apparent to the person of ordinary skill in the art having the benefit of the present disclosure and need not be described further.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A packaged body support article, comprising:
a body support article predominantly comprising one or more foams, wherein the body support article is compressed and rolled, and wherein the body support article is selected from the group consisting of mattresses, mattress toppers, pillows, and cushions;
a sealed, airtight material maintaining the body support article in the rolled state; and
a container comprising a dispensing port and housing a composition, wherein the composition comprises:
a solvent; and
a compound selected from antimicrobial compounds or antiviral compounds;
wherein the compound is soluble in the solvent and/or emulsifiable in the solvent;
the solvent and the compound are present in the composition at concentrations such that the composition are non-toxic to humans, dogs, and cats; and
the composition is capable of being applied onto a surface.

2. The packaged body support article of claim 1, wherein the composition further comprising a scenting agent.

3. The packaged body support article of claim 1, wherein:
the solvent readily evaporates at room temperature and 100% relative humidity; and
the composition is capable of application as a spray or an aerosol to the surface.

4. The packaged body support article of claim 1, wherein the compound is selected from the group consisting of silver ion compounds; zinc compounds; copper compounds; quaternary ammonium compounds (“quats”); oxazoline homopolymers; oxazoline copolymers; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles; polyhexamethylene biguanide hydrochloride; 3,4,4′-trichlorocarbanilide; isothiazolone-based compounds; alkyl dimethyl ammonium saccharinate; benzalkonium chlorides; oxathiazines; chlorothalonil; and two or more thereof.

5. The packaged body support article of claim 1, further comprising:
an emulsifier configured to enhance solubility of the compound, the scenting agent, or both in the solvent.

6. The packaged body support article of claim 5, further comprising an essential oil, wherein the essential oil is selected from the group consisting of green tea oil, sweet orange oil, menthol oil, peppermint oil, cedarwood oil, lemon oil, eucalyptus oil, aromatic litsea/mountain pepper oil, clove oil, spearmint oil, rose oil, lemongrass oil, lavender oil, thyme oil, alfalfa oil, allspice oil, ambrette (seed) oil, angelica root oil, angelica seed oil, angelica stem oil, angostura (cusparia bark) oil, anise oil, asafetida-foetida oil, balm (lemon balm) oil, balsam of peru oil, basil oil, bay leaves oil, bay (myrcia oil) oil, bergamot (bergamot orange) oil, bitter almond oil, bois de rose oil, cacao oil, camomile (chamomile) flowers oil, cananga oil, capsicum oil, caraway oil, cardamom seed (cardamon) oil, carob bean oil, carrot oil, cascarilla bark oil, cassia bark oil, chinese oil, cassia bark oil, padang or batavia oil, cassia bark oil, saigon oil, celery seed oil, cherry oil, wild oil, bark oil, chervil oil, chicory oil, cinnamon bark oil, ceylon oil, cinnamon bark oil, chinese oil, cinnamon bark oil, saigon oil, cinnamon leaf oil, ceylon oil, cinnamon leaf oil, chinese oil, cinnamon leaf oil, saigon oil, citronella oil, citrus peels oil, clary (clary sage) oil, clover oil, coca (decocainized) oil, coffee oil, cola nut oil, coriander oil, cumin (cummin) oil, curacao orange peel (orange oil, bit oil, cusparia bark oil, dandelion oil, dandelion root oil, dog grass (quackgrass oil, triticum) oil, elder flowers oil, estragole (esdragol oil, esdragon oil, t oil, estragon (tarragon) oil, fennel oil, sweet oil, fenugreek-gr oil, galanga (galangal) oil, geranium oil, east indian oil, rose oil, ginger oil, grapefruit oil, guava oil, hickory bark oil, horehound (hoarhound) oil, hops oil, horsemint oil, hyssop oil, immortelle oil, jasmine oil, juniper (berries) oil, kola nut oil, laurel berries oil, laurel leaves oil, lavender oil, lavender oil, spike oil, lavandin oil, lemon(l.) burm. oil, lemon balm oil, lemongrass oil, lemon peel(l.) oil, lime oil, linden flowers oil, locust bean oil, oil, lupulin oil, mace oil, mandarin oil, marjoram oil, sweet oil, yerba mate oil, melissa (see balm) oil, menthol oil, menthyl acetate oil, molasses (extract) oil, mustard oil, naringin oil, neroli oil, bigarade oil, nutmeg oil, onion oil, orange oil, bitter oil, flowers oil, orange oil, bitter oil, peel oil, orange leaf(l.) oil, orange oil, sweet oil, orange oil, sweet oil, flowers oil, orange oil, sweet oil, peel oil, origanum oil, palmarosa oil, paprika oil, parsley(mi oil, pepper oil, black oil, pepper oil, white oil, peppermint oil, peruvian balsam oil, petitgrain oil, petitgrain lemon oil, petitgrain mandarin or tangerine oil, pimenta oil, pimenta leaf oil, pipsissewa leaves oil, pomegranate oil, prickly ash bark oil, rose absolute oil, rose (otto of roses oil, attar of roses) oil, rose buds oil, rose flowers oil, rose fruit (hips) oil, rose geranium oil, rose leaves oil, rosemary oil, saffron oil, sage oil, sage oil, greek oil, sage oil, spanish oil, st. john's bread oil, savory oil, summer oil, savory oil, winter oil, schinus molle oil, sloe berries (blackthorn berries) oil, spearmint oil, spike lavender oil, tamarind oil, tangerine oil, tarragon oil, tea oil, thyme oil, thyme oil, white oil, thyme oil, wild or creeping oil, tuberose oil, turmeric oil, vanilla oil, violet flowers oil, violet leaves oil, violet leaves absolute oil, wild cherry bark oil, ylang-ylang oil, and zedoary bark oil.

7. The packaged body support article of claim 1, wherein the solvent is at least one of:
a first solution in which an antimicrobial compound is capable of being dissolved or aerosolized; or
a second solution in which an antiviral compound is capable of being dissolved or aerosolized.

8. The packaged body support article of claim 1, wherein:
the antimicrobial compound is capable of inhibiting the growth or reproduction of at least one of:
at least one bacterium;
at least one mold; or
at least one mildew;
and
the antiviral compound is capable of inhibiting the infectiveness of at least one virus.

9. The packaged body support article of claim 2, wherein the solvent, the compound, and the scenting agent are present in the composition at concentrations such that the amount of each in 0.5 liters of the composition are non-toxic to humans, dogs, and cats.

10. A method, comprising:
forming a body support article predominantly comprising one or more foams, wherein the body support article is selected from the group consisting of mattresses, mattress toppers, pillows, and cushions;
compressing the body support article;
rolling the body support article;
sealing the compressed and rolled body support article in an airtight material;
positioning the sealed body support article in a packaging article; and
including in the packaging article a container comprising a dispensing port and housing a composition, wherein the composition comprises:
a solvent;
a compound selected from antimicrobial compounds or antiviral compounds; and
a scenting agent;
wherein the compound and the scenting agent are soluble in the solvent and/or emulsifiable in the solvent;
the solvent, the compound, and the scenting agent are present in the composition at concentrations such that the amount of each in 0.5 liters of the composition are non-toxic to humans, dogs, and cats;
the solvent readily evaporates at room temperature and 100% relative humidity; and
the composition is capable of application as a spray or an aerosol to a surface.

11. The method of claim 10, further comprising applying the composition onto at least one surface of the body support article.

12. The method of claim 11, wherein the compound is selected from the group consisting of silver ion compounds; zinc compounds; copper compounds; quaternary ammonium compounds (“quats”); oxazoline homopolymers; oxazoline copolymers; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles; polyhexamethylene biguanide hydrochloride; 3,4,4′-trichlorocarbanilide; isothiazolone-based compounds; alkyl dimethyl ammonium saccharinate; benzalkonium chlorides; oxathiazines; chlorothalonil; and two or more thereof.

13. The method of claim 10, wherein the packaging article comprises cardboard, paper, paperboard, metal, viscoelastic foam, flexible plastic, rigid plastic, or two or more thereof.

14. The method of claim 10, wherein including the container in the packaging article comprises co-rolling the container with the body support article.

15. The method of claim 10, wherein:
forming the body support article further comprises forming a pocket or recess in the body support article; and
including the container in the packaging article comprises inserting the container in the pocket or recess.

16. A system, comprising:
a processing controller configured to control a body support article packaging system; and
the body support article packaging system, wherein the body support article packaging system is configured to:
form a body support article predominantly comprising one or more foams, wherein the body support article is selected from the group consisting of mattresses, mattress toppers, pillows, and cushions;
compress the body support article;
roll the body support article;
seal the compressed and rolled body support article in an airtight material;
position the sealed body support article in a packaging article; and
include in the packaging article a container comprising a dispensing port and housing a composition, wherein the composition comprises:
a solvent;
a compound selected from antimicrobial compounds or antiviral compounds; and
a scenting agent;
wherein the compound and the scenting agent are soluble in the solvent and/or emulsifiable in the solvent;
the solvent, the compound, and the scenting agent are present in the composition at concentrations such that the amount of each in 0.5 liters of the composition are non-toxic to humans, dogs, and cats;
the solvent readily evaporates at room temperature and 100% relative humidity; and
the composition is capable of application as a spray or an aerosol to a surface.

17. The system of claim 16, wherein the compound is selected from the group consisting of silver ion compounds; zinc compounds; copper compounds; quaternary ammonium compounds (“quats”); oxazoline homopolymers; oxazoline copolymers; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles; polyhexamethylene biguanide hydrochloride; 3,4,4′-trichlorocarbanilide; isothiazolone-based compounds; alkyl dimethyl ammonium saccharinate; benzalkonium chlorides; oxathiazines; chlorothalonil; and two or more thereof.

18. The system of claim 15, wherein the composition further comprises:
an emulsifier to enhance solubility of the compound, the scenting agent, or both in the solvent; and
an essential oil, wherein the essential oil is selected from the group consisting of green tea oil, sweet orange oil, menthol oil, peppermint oil, cedarwood oil, lemon oil, eucalyptus oil, aromatic litsea/mountain pepper oil, clove oil, spearmint oil, rose oil, lemongrass oil, lavender oil, thyme oil, alfalfa oil, allspice oil, ambrette (seed) oil, angelica root oil, angelica seed oil, angelica stem oil, angostura (cusparia bark) oil, anise oil, asafetida-foetida oil, balm (lemon balm) oil, balsam of peru oil, basil oil, bay leaves oil, bay (myrcia oil) oil, bergamot (bergamot orange) oil, bitter almond oil, bois de rose oil, cacao oil, camomile (chamomile) flowers oil, cananga oil, capsicum oil, caraway oil, cardamom seed (cardamon) oil, carob bean oil, carrot oil, cascarilla bark oil, cassia bark oil, chinese oil, cassia bark oil, padang or batavia oil, cassia bark oil, saigon oil, celery seed oil, cherry oil, wild oil, bark oil, chervil oil, chicory oil, cinnamon bark oil, ceylon oil, cinnamon bark oil, chinese oil, cinnamon bark oil, saigon oil, cinnamon leaf oil, ceylon oil, cinnamon leaf oil, chinese oil, cinnamon leaf oil, saigon oil, citronella oil, citrus peels oil, clary (clary sage) oil, clover oil, coca (decocainized) oil, coffee oil, cola nut oil, coriander oil, cumin (cummin) oil, curacao orange peel (orange oil, bit oil, cusparia bark oil, dandelion oil, dandelion root oil, dog grass (quackgrass oil, triticum) oil, elder flowers oil, estragole (esdragol oil, esdragon oil, t oil, estragon (tarragon) oil, fennel oil, sweet oil, fenugreek-gr oil, galanga (galangal) oil, geranium oil, east indian oil, rose oil, ginger oil, grapefruit oil, guava oil, hickory bark oil, horehound (hoarhound) oil, hops oil, horsemint oil, hyssop oil, immortelle oil, jasmine oil, juniper (berries) oil, kola nut oil, laurel berries oil, laurel leaves oil, lavender oil, lavender oil, spike oil, lavandin oil, lemon(l.) burm. oil, lemon balm oil, lemongrass oil, lemon peel(l.) oil, lime oil, linden flowers oil, locust bean oil, oil, lupulin oil, mace oil, mandarin oil, marjoram oil, sweet oil, yerba mate oil, melissa (see balm) oil, menthol oil, menthyl acetate oil, molasses (extract) oil, mustard oil, naringin oil, neroli oil, bigarade oil, nutmeg oil, onion oil, orange oil, bitter oil, flowers oil, orange oil, bitter oil, peel oil, orange leaf(l.) oil, orange oil, sweet oil, orange oil, sweet oil, flowers oil, orange oil, sweet oil, peel oil, origanum oil, palmarosa oil, paprika oil, parsley(mi oil, pepper oil, black oil, pepper oil, white oil, peppermint oil, peruvian balsam oil, petitgrain oil, petitgrain lemon oil, petitgrain mandarin or tangerine oil, pimenta oil, pimenta leaf oil, pipsissewa leaves oil, pomegranate oil, prickly ash bark oil, rose absolute oil, rose (otto of roses oil, attar of roses) oil, rose buds oil, rose flowers oil, rose fruit (hips) oil, rose geranium oil, rose leaves oil, rosemary oil, saffron oil, sage oil, sage oil, greek oil, sage oil, spanish oil, st. john's bread oil, savory oil, summer oil, savory oil, winter oil, schinus molle oil, sloe berries (blackthorn berries) oil, spearmint oil, spike lavender oil, tamarind oil, tangerine oil, tarragon oil, tea oil, thyme oil, thyme oil, white oil, thyme oil, wild or creeping oil, tuberose oil, turmeric oil, vanilla oil, violet flowers oil, violet leaves oil, violet leaves absolute oil, wild cherry bark oil, ylang-ylang oil, and zedoary bark oil.

19. The system of claim 15, wherein the container is selected from the group consisting of a spray bottle and an aerosol can.

20. The system of claim 15, wherein:
the packaging article comprises cardboard, paper, paperboard, metal, viscoelastic foam, flexible plastic, rigid plastic, or two or more thereof;
the body support article packaging system is configured to include the container in the packaging article by co-rolling the container with the body support article;
the body support article packaging system is configured to form a pocket or recess in the body support article; and
the body support article packaging system is configured to include the container in the packaging article by inserting the container in the pocket or recess.
